(19) United States
(12) Patent Application Publication
(10) Pub. No.: US 2009/0141261 A1
(43) Pub. Date: Jun. 4, 2009

(54) ELECTRO-OPTICAL OUTPUT UNIT AND MEASURING DEVICE COMPRISING SAID ELECTRO-OPTICAL OUTPUT UNIT

(76) Inventors: Heiner Lukas, Stuttgart (DE); Wolfgang Adamczak, Stuttgart (DE); Steffen Tiede, Herrenberg (DE)

Correspondence Address: MICHAEL J. STRIKER, 103 EAST NECK ROAD, HUNTINGTON, NY, 11743, US

(21) Appl. No.: 12/278,312

(22) PCT Filed: Feb. 12, 2007
(86) PCT No.: PCT/EP2007/051354

§ 371 Date: Aug. 5, 2008

(30) Foreign Application Priority Data
Mar. 24, 2006 (DE) 10 2006 013 695.0

(51) Int. Cl. G01C 3/08

(52) U.S. Cl. 356/4.01

(57) ABSTRACT

The invention relates to an electro-optical output unit (30, 31, 32, 130, 132) for representing measured distance values, especially an electro-optical output unit (30, 31, 32, 130, 132) for a hand-held length-measuring device. The invention is characterized in that the output unit (30, 31, 32, 130, 132) is adapted to represent a variable length meter scale (40, 52, 140) which changes with varying measuring distance of the device to a reference point of the distance measurement. The invention also relates to a measuring device, especially a hand-held distance measuring device, comprising said electro-optical output unit.

The present invention relates to an electro-optical output unit for displaying measured distance values, in particular an electro-optical output unit for a hand-held length-measurement device. The present invention also relates to a measurement device, in particular a hand-held distance-measuring device with an electro-optical output unit.

### RELATED ART

In the determination of distances, a distinction in made between a direct measurement by making a direct comparison of a section with a measurement means, e.g., a ruler, a tape-measure, or a folding rule, and by performing an indirect measurement, e.g., a contactless, electro-optical distance-measurement. Electro-optical distance-measuring devices make it possible to determine distances, e.g., using transit time or phase measurements of an emitted modulated measurement signal.

Measurement devices or measurement-related components of hand-held devices used to measure distance indirectly, i.e., contactless electronic measurements, such as laser or ultrasonic distance-measuring devices typically include electro-optical display elements that assign a displayed value—the desired distance value—to an individual measurement.

Measurement devices or measurement-related components of hand-held devices for measuring distances directly, with which the magnitude of the particular distance is determined by comparing a distance directly with the measurement means, typically include a fixed, mechanical measurement scale, e.g., a ruler, a tape-measure, or a folding rule.

Publication EP 1 566 658 A1 makes known a hand-held device for measuring distances that emits transmission beams via optics located in a housing toward the background region of an object to be measured, and then collects the reflected beams. This device also includes a mechanical component that is connected with the housing, and which may be extended beyond the housing in order to measure short distances in the direction of propagation of the transmission beams. One embodiment of the device described in EP 1 566 658 A1 provides a component that serves as a spacer and extends with a fixedly predetermined length beyond the housing of the device.

The device described in EP 1 566 658 A1 also includes a tape-measure, which may be pulled out of the housing of the device, in order to determine distances of the device from a reference point.

### DISCLOSURE OF THE INVENTION

The inventive electro-optical output unit for displaying measured distance values advantageously makes it possible to display a variable length-measurement scale via the output unit, the length-measurement scale changing, e.g., as the distance measured between the related device—in particular a hand-held length-measurement device—and a reference point varies. Using the inventive output unit, it is possible to display not only a single measured value for a distance to be measured, but also to provide a length-measurement scale for a user of the device, which includes the measured distance value and a great deal of other distance values, in particular in the form of a measurement scale. The measured distance values that are displayed are therefore depicted as a measurement scale based on their actual distances from each other. The length-measurement scale also changes accordingly as the distance between the length-measurement device and a reference point varies. That is, the scale shifts while maintaining correct proportionality between distances, e.g., as the distance to be measured increases or decreases. This advantageously makes it possible to determine the measured distance value and to perform measurement-related tasks, such as determining and marking points, lines, and paths.

When an inventive output unit of this type is integrated in a measuring device, in particular in a hand-held distance-measuring device, a measuring device of this type makes it possible—via the length-measurement scale that is displayable in the inventive electro-optical output unit—to determine individual measured distance values and to determine and/or mark off section lengths relative to the distance value that was measured.

With a measuring device used to measure distance in a contactless manner in particular, the inventive electro-optical output unit makes it possible to perform a measurement that is not limited to the length or physical extension of the device. Rather, a measuring device of this type, which has an extension, e.g., of only a few decimeters in the measuring direction, may be used to measure section lengths of up to a few hundred meters, and to depict a portion of this section length via the measurement scale of the inventive output unit.

The inventive output unit makes it possible to display an entire length-measurement scale, which depicts, e.g., a finite range of a section to be measured. In this manner, a device equipped with the inventive electro-optical output unit serves as a meter rule, in particular a digital meter rule, with a measurement scale, in particular a length-measurement scale, which is displayable in the output unit of the device, and which may display the measured distance values across an entire subsection of the section that was measured. A user is therefore advantageously informed of a specific distance value between the measuring device and an object to be measured, and he has—as with a measuring device for measuring distances directly—a measurement scale that depicts the particular distance between a point on the scale and the object to be measured, across a range having a finite length.

Advantageous refinements of the inventive device or an inventive measuring device with a device of this type are possible due to the features listed in the dependent claims.

It is advantageously possible, using the inventive electro-optical output unit, to depict a variable length-measurement scale that changes as the measuring distance of the related device increases and/or decreases, in accordance with the distance measured between a target object that serves as a reference point and a reference point of the device.

The length-measurement scale of the inventive device advantageously includes, to this end, scale divisions and/or numerical values, the magnitude of which correspond to the particular distance of the related scale division to an object to be measured and/or a reference point. When the distance between the device and a reference point varies while a measurement is being performed, or when the distance between two consecutive measurements varies, the scale divisions and/or the numerical values assigned to the scale divisions are varied accordingly, i.e., they are updated and communicated to a user in their updated form via the electro-optical output unit.

This updating of the length-measurement scale may take place, e.g., continually and automatically, or incrementally, as soon as a related measuring device operates in a “fixed measurement mode” and thereby measures the distance between the device and a reference point in a continual manner.

In an advantageous and user-friendly manner, the orientation of the measurement scale relative to the output unit may be switched, thereby ensuring optical visibility of the electro-optical output unit for a user, e.g., depending on the data from an associated tilt sensor.

Advantageously, the zero pont of the length-measurement scale may be located outside of the measuring range displayed in the electro-optical output unit, and it may be determined, e.g., by performing a distance measurement, in particular an electro-optical distance measurement. This makes it possible to measure relatively long sections while also providing an exact and possibly very finely-divided length-measurement scale for a subsection of the section to be measured.

The electro-optical output unit is advantageously designed as an electro-optical display, with which scale marks, measured values, and other data may be displayed in a digital, electro-optical manner in particular. The depiction of the length-measurement scale and associated scale divisions may take place, e.g., by controlling the display in a vector-oriented manner, via a grid or matrix display, or, e.g., via a segment display.

With an inventive measuring device, in particular a hand-held distance measuring device with an electro-optical output unit of this type, the output unit itself and/or the depiction of a measurement scale via the output unit is advantageously located essentially parallel to a lay edge of the housing of the measuring device. This makes it easy to transfer measured values from the measurement scale of the electro-optical output unit, e.g., to a background. To this end, a measuring device of this type may include an additional scale, a fixed division scale in particular, which makes it easier to transfer the length-measurement scale of the electro-optical output unit to a background. An additional scale of this type, with is located, e.g., on the housing of the measuring device, may be advantageously formed, in particular, in the region of a lay edge of the housing of the measuring device.

A measuring device with the inventive electro-optical output unit combines the advantages of indirect and direct length measurement. Distances that may be measured and/or marked off only by using a ruler or a conventional meter rule—in a laborious manner, if at all—may now be easily ascertained and characterized. For example, sections that are several meters long may also be determined as a “one-man operation”, due to the compact design of a measuring device of this type. The process of transferring a measure from a measuring device of this type, e.g., to a background is simplified and greatly accelerated, since the device need not be positioned at an exact point in the direction of the distance to be measured.

Further advantages of the inventive device and/or of an inventive measuring device result from the description, below, of a few exemplary embodiments of the inventive devices.

### DRAWING

Exemplary embodiments of the inventive device and/or of measuring devices with an inventive device of this type are depicted in the drawing, and they are described in greater detail in the subsequent description. The figures in the drawing, their descriptions, and the claims contain numerous features in combination. One skilled in the art will also consider the features individually and combine them to form further reasonable combinations. One skilled in the technical art will also combine the features of different exemplary embodiments to form further reasonable combinations.

FIG. 1 shows a first exemplary embodiment of a measuring device with an inventive electro-optical output unit,

FIG. 2 shows an exemplary embodiment of a display of an electro-optical output unit of a measuring device according to FIG. 1,

FIG. 3 shows a second exemplary embodiment of a display of an electro-optical output unit for a measuring device according to FIG. 1,

FIG. 4 shows a second exemplary embodiment of a measuring device with an inventive electro-optical output unit,

FIG. 5 shows a further exemplary embodiment of a measuring device with an inventive electro-optical output unit,

FIG. 6 shows the electro-optical output unit of the measuring device in FIG. 4, in a detailed view,

FIG. 7 shows a display of the electro-optical output unit in the “memory mode”.

### DESCRIPTION OF THE EXEMPLARY EMBODIMENTS

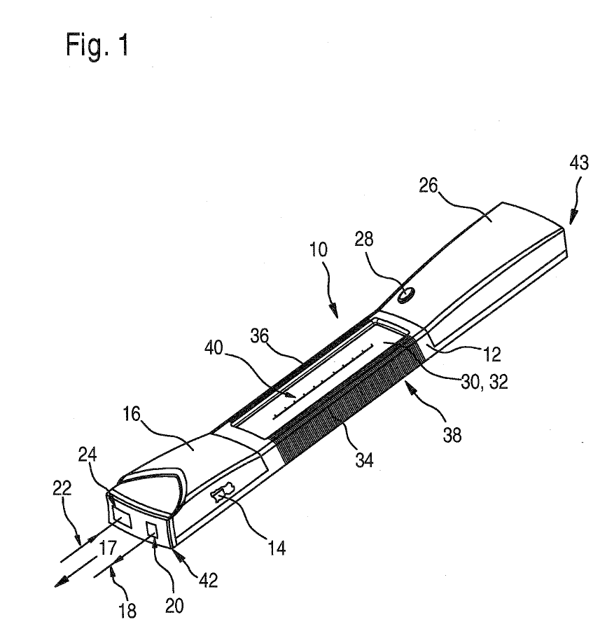

FIG. 1 is a schematic overview illustration of a distance-measuring device with an inventive electro-optical output unit.

Measuring device 10 includes a housing 12, inside of which electronic components for signal generation, signal detection, and signal evaluation are located. These electronic components are labelled as a group and symbolically with reference numeral 14 in the overview depiction in FIG. 1. In addition to these electronic elements, the interior of the housing may include additional optical elements—depending on the embodiment—such as lenses and objectives. Mechanical elements, e.g., mechanical connections, may also be located inside housing 12. The device also includes all known components of a distance-measuring device, in particular an electro-optical distance-measuring device.

Measuring device 10 has a measurement head 16, in which components 14 for electro-optical distance measurement are integrated. Measurement signal 18 exits the housing of the device via outlet window 20 and is reflected and/or scattered on a target object, which is not shown in FIG. 1, and which serves as the reference point for a distance measurement between the measuring device and the target object. A returning portion 22 of the measurement beams returns to the device via inlet window 24. In the device, it is converted into an electronic signal and is evaluated using electronic components 14. The distance between the target object and measuring device 10, in particular the distance between the target object—which serves as the reference point—and a reference point of the device, may be detected in a known manner via a transit time or phase measurement of measurement signal 18 or 22, which serves to determine, e.g., the relative phase shift between measurement signal 18 traveling to the target object and measurement signal 22 that was reflected on the target object and is returning to the measuring device.

Within the framework of the description of the inventive device, reference is made to publications DE 102 32 878 A1 and DE 198 11 550 A1 for a more detailed explanation of the mode of operation of a device of this type for measuring distance. Those publications describe a basic possible mode of operation of a distance-measuring device of this type, which is designed as a laser distance-measuring device. In addition to the laser distance-measuring device described here, an ultrasonic distance-measuring device or a radar distance-measuring device are also feasible, for instance, in an analog manner.

The inventive measuring device according to the embodiment shown in FIG. 1 includes an evaluation and computer unit 26 on its end opposite to measurement head 16. Operating elements and input buttons for the measuring device, for instance, may be installed in the region of evaluation and computer unit 26. They are depicted symbolically as operating element 28 in FIG. 1. In alternative embodiments, the measurement head and computer unit may be integrated in a single housing part, and they may be installed on only one side of the measurement scale.

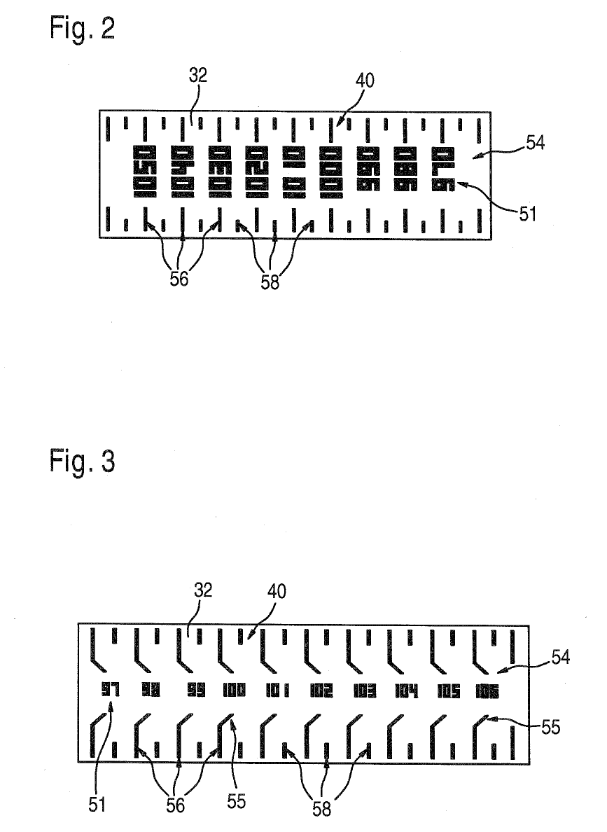

With the inventive measuring device shown in FIG. 1, an output unit 30 designed as an electro-optical display 32 is located between measurement head 16 and computer unit 26. Electro-optical display 32 serves to display, digitally in particular, scale marks and scale values of a length-measurement scale, as shown in FIG. 2 and FIG. 3, for instance. Electro-optical display 32 may include a vector-oriented control, or it may be realized as a grid or matrix display. It is also possible to design electro-optical display unit 30 as a segment display, e.g., a 7-segment display or a 14-segment display.

The embodiment of measuring device 10 shown in FIG. 1 includes a fixed scale 34 or 36 with equidistant scale marks, which is installed on the housing, on both longitudinal sides of electro-optical display 29. Scales 34 and 36 are used to transfer the measured values obtained with the measuring device, e.g., to a background.

Output unit 30 has an extension in measurement signal direction 17 that is much greater than the extension in the direction orthogonal thereto. In preferred embodiments, the extension of output unit 30 in measurement signal direction 17 is many times greater than the extension in the direction perpendicular thereto. With measuring devices of the type shown in FIG. 1, the extension of the electro-optical output unit in the measurement signal direction may be, e.g., 10 to 30 cm, while the extension in the direction orthogonal thereto may be only 2 to 5 cm, for instance. In this manner, a digital meter rule may be realized with the inventive measuring device, the mode of operation and appearance of which are similar to those of a conventional, purely mechanical meter rule.

Electro-optical display 32 is oriented essentially parallel to direction 17 of measurement signal 18 and parallel to a lay edge 38 of housing 12 of the measuring device.

After measuring device 10 is switched on, e.g., using operating elements 28, a ruler scale 40, for instance, with discrete scale divisions is depicted directly in display 32 of output unit 30 across the entire longitudinal extension of output unit 30. The means for contactless distance measurement are not yet activated in this measurement mode. The reference point for the length measurement scale is then, naturally, end 42 of housing 12 on the side of the measurement head. In this passive functional mode, the measuring device is equivalent to a classical ruler or a meter rule, but with a digital, electro-optical depiction of the scale values. In a measurement mode of this type, the inventive device may be used like a normal, classical meter rule for measuring and marking off lengths directly.

Advantageously, in this passive operating mode, the reference point for the length measurement may also be switched, so that, e.g., end 43 of the housing that faces away from the measurement head may be used as the reference point.

Advantageously, it is also possible to switch between different measurement systems, such as the common metric system used in Europe, and the U.S. inch system.

FIG. 2 and FIG. 3 show possible depictions of a digital measurement scale of the electro-optical output unit, which are described in greater detail below.

Advantageously, the measuring device may include at least one tilt sensor, e.g., an inclinometer or a tilt switch, which orients the numerical values assigned to the scale divisions in accordance with the orientation of the measuring device.

When, with the measuring device according to the embodiment depicted in FIG. 1, measurement signal 18 or 22 for contactless distance measurement is activated by a related operating element 28, the distance between the scale divisions of the electro-optical display unit and housing edge 42 or 43 is no longer displayed, but rather the distance between the scale divisions shown and a target object 18, which now serves as a reference point. The zero point of the length-measurement scale that is displayed is therefore not only located outside of the scale range that may be depicted in output unit 30, but also outside of the device housing. To generate the length-measurement scale, the distance between the target object and a reference plane or a reference point of the inventive measuring device is determined, e.g., using the known phase-measurement procedure and, based on the particular distance between a target object and this reference point of the measuring device, a corresponding length scale 40 is generated in output unit 30 via computation, which depicts the distances between the scale divisions of this measurement scale and a reference point of the target object. In this mode of operation of the inventive device, distances between the measuring device and a target object may be depicted across the entire range of length-measurement scale 40 shown in display 32, thereby making it possible, e.g., to also mark off sections of a desired length relative to the reference point.

If, e.g., in a fixed measurement mode, with which a contactless distance measurement is performed continually using measurement signal 18 or 22, the distance between a target object and the measuring device changes, this is accounted for by evaluation and computation unit 26, and length-measurement scale 40 of output unit 30 of measuring device 10 is automatically updated electronically, so that it depicts the distance between individual scale divisions and the target object in an exact and up-to-date manner.

The inventive measuring device is therefore equivalent to a meter rule, in particular a digital meter rule, whose zero point of measurement scale 40 is located outside of measurement scale 40 displayed in output unit 30. When measurement signal 18 is active, i.e., when a contactless distance measurement is carried out, the zero point of measurement scale 40 may also lie, in particular, clearly outside of housing 12 of measuring device 10.

In alternative embodiments or alternative measurement modes, measurement signal 18 may also be activated directly after the measuring device is switched on, so that the measuring device is immediately in a second, contactless measurement mode described above. The measuring device may operate, e.g., in a fixed measurement mode, in which the current distance between the device and the particular target object is measured in an uninterrupted manner or with a special clock rate, and is depicted using inventive electro-optical output unit 30.

In an alternative manner, a further measurement mode of the inventive device may provide only a single measurement, which is initiated, e.g., when an operating element is actuated. In accordance with the distance to the target object that is measured, the length-measurement scale is depicted using electro-optical length-measurement unit 30, e.g., in a single fixed, digital image, as shown in FIG. 2 and FIG. 3 as an example.

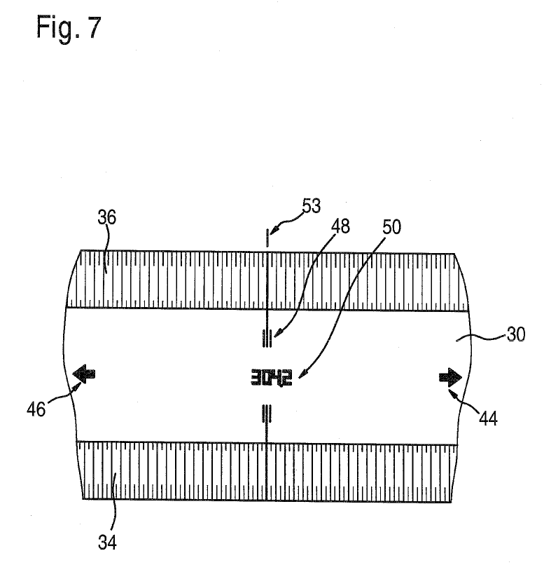

With the inventive measuring device, it is also possible, e.g., to record a single measured value in a single measurement, and to store it using a memory function. This stored or “tapped” measured value may now be transferred easily to another background using the inventive device. In the memory mode, output unit 30 indicates, e.g., using arrows 44 and 46, in which direction the measuring device should be slid so that the section that is currently being measured corresponds to the section that was previously recorded and stored. One possible depiction of the display of the electro-optical output unit in the “memory mode” is shown in FIG. 7. If end point 48 of the section to be marked off is located in the length range that is displayable on the output unit, a related mark 48 is displayed in the electro-optical display of the output unit. At the same time, previously determined numerical value 50, i.e., the section that was measured using the ruler and is to be marked off, is also displayed in output unit 30 of the measuring device. Advantageously, mark 48 and/or numerical value 50 to be marked off do not need to be located at any particular point in the output unit. They only need to fall within the range of the length-measurement scale that is displayable in the output unit. Using mark 48 of the electro-optical output unit, the corresponding measure (304.2 cm in the exemplary embodiment shown in FIG. 7) may be transferred to a background via fixed scale 34 or 36—which is provided on the housing of the measuring device—as indicated symbolically with mark 53 in FIG. 7. In this manner it is possible to transfer a measure that was recorded or “tapped” once to a large number of backgrounds. For instance, a single-length measure may be easily applied to a large number of boards, which may then be cut.

As an alternative, it is also possible with the inventive measuring device to not measure or tap measured value 50 to be transferred, but rather to enter it directly in a storage medium of the measuring device via a keypad with digits or a rotating wheel. The output unit of the device then indicates, in memory mode and using arrow symbols of output unit 30, in which direction the measuring device must be slid relative to a target object, so that the section between the measuring device and the target object currently being measured reaches the previously stored value.

The device also includes a reset function, with which the measured distance value memory may be reset to zero, thereby enabling the starting point of the distance measurement to be reset. In this manner it would be advantageously possible to measure different sections and to display them directly.

In further embodiments of an inventive measuring device, it may be provided, for instance, that measurement head 16 is detachable from the rest of the housing, as a separate component or a functional module. If a receiving unit is also integrated in the rest of the housing, the distance between measurement head 16 and the rest of the housing and, in particular, the measurement scale, may be ascertained. In this case, the electro-optical output unit would be integrated in the reception module of a related measuring device. The target object in this embodiment would therefore be the measurement head itself or the reception module.

FIGS. 2 and 3 show possible embodiments of length-measurement scales 40 that are displayable using the inventive electro-optical output unit. Display 32 includes a digital display 54 with a variable scale 40, which is composed of scale marks 56 and assigned numerical values 51. The position of scale marks 56 and/or assigned numerical values 51 changes as the distance between the measuring device and a reference point, e.g., a target object, increases or decreases. In the exemplary depictions of the inventive electro-optical output unit shown in FIGS. 2 and 3, scale divisions 56 are 1 cm-increments. This scale is subdivided further into 5 mm-increments by additional scale divisions 58. A further subdivision, e.g., into 1 mm-increments, is also possible, and may be displayed in the output unit, e.g., if so prompted by the user. An embodiment of the inventive electro-optical output unit may also be advantageous with which the scale may be divided into more or fewer increments, depending on the absolute distance from a reference point that is measured. For example, the measurement uncertainty of the measuring device may be adapted to the absolute distance between the device and the target object, as was proposed by the applicant in DE 102 32 878 A1 for electro-optical distance-measuring devices.

In the embodiments shown in FIGS. 2 and 3, numerical values 51 are assigned to scale divisions 56, which indicate the particular distance between each scale division 56 and a reference point, e.g., a target object of the contactless distance measurement. The inventive output unit and/or an inventive measuring device therefore displays the distance between a target object and a reference plane, e.g., a reference point of the measuring device, and displays the absolute distances of the measurement scale relative to the reference point, within a finite range. The absolute distance between measurement points and a reference point, e.g., a target object, may be read out across the entire range of the output unit. A relative distance between these measurement points may therefore be marked off, e.g., on a background. It is therefore easily possible with the inventive measuring device, e.g., to transfer a section to a background that is oriented horizontally, has a length of 15.2 cm, and whose starting point is located 7.23 m away from the reference point being aimed at.

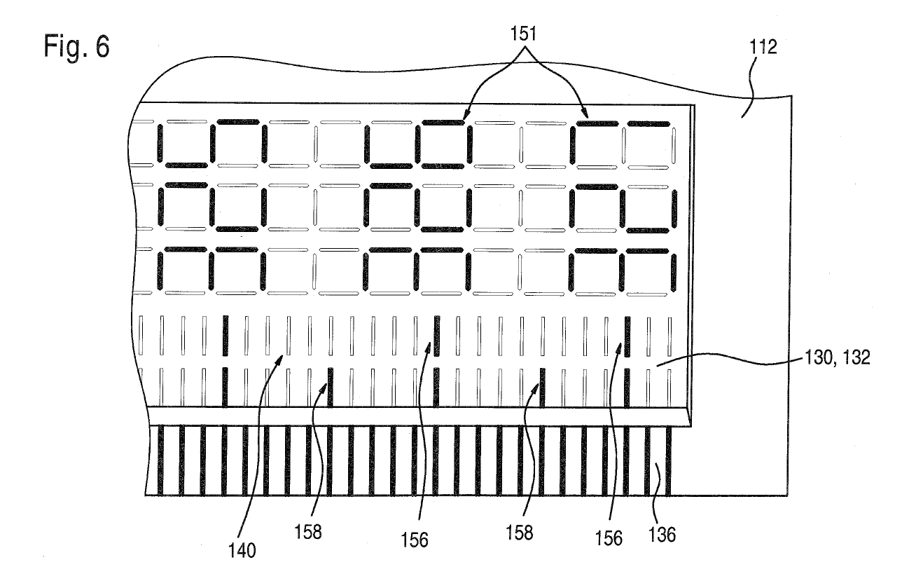

When the distance between the measuring device and a target object is changed, length-measurement scale 40 shown in the output unit therefore also shifts accordingly, in order to depict the new distances. As shown in FIG. 3 in particular, numerical value 51 may initially remain in its previous position in the output unit, while only scale marks 56 and 58 are adjusted. Scale marks 56 and 58 move in the related direction by the amount of the displacement of the measuring device relative to the target object. To realize an unambiguous relationship between shifted scale marks 56 and 58 and measured values 51 that are displayed but which have not moved, scale marks 56 may be displayed in this case such that they are provided, e.g., with an extension 55 in the form of a “flag”, with extensions 55 pointing to associated numerical value 51. In this manner, it is possible—with segment displays in particular—for the actual scale mark to jump one segment further, while only the orientation of the “flag” changes, to retain the reference to the fixed numerical values. When the distance between the measuring device and a target object is increased further, the numerical value may be updated in the output unit and, e.g., change its position. Using a measurement scale of the type shown in FIG. 6, for example, it is possible to change the numerical values in increments of 3 millimeters. For intermediate measured values, the numerical values remain in a fixed position in the measurement scale, and only the scale marks travel accordingly across the output unit.

As an alternative, it is advantageously possible for flag 55 at scale marks 56 or 58 to move across a length-measurement range of, e.g., less than 5 millimeters, or to change its orientation, while the associated numerical value remains in its position in the display, unchanged, over this interval. When the change in the measured distance from a target object becomes exactly 5 millimeters, flag 55 on the scale mark disappears, and the numerical value, which was previously, e.g, 100 cm, is changed to a value of 100.5 cm.

In this manner, the inventive electro-optical output unit provides a nearly continually variable length-measurement scale, which is also capable of displaying small intermediate intervals and changes in distance to be measured. In particular, it thereby becomes possible to largely avoid the disadvantages of a discretization in the output unit, which are unavoidable due to, e.g., a segment display.

In addition to the embodiments of the electronic length-measurement scale shown in FIGS. 1, 2, and 3, and in FIG. 6 or 7, depending on the application, it is also possible to depict only a portion of the entire measurement range, or to depict only a single measured value, thereby making it possible—as with conventional laser distance-measuring devices—to also perform individual measurements, e.g., relative to a reference point or a reference edge of the device (e.g., the front or rear end of the measuring device). In particular, it is provided that the reference point—on the device—for the distance measurement may be switched.

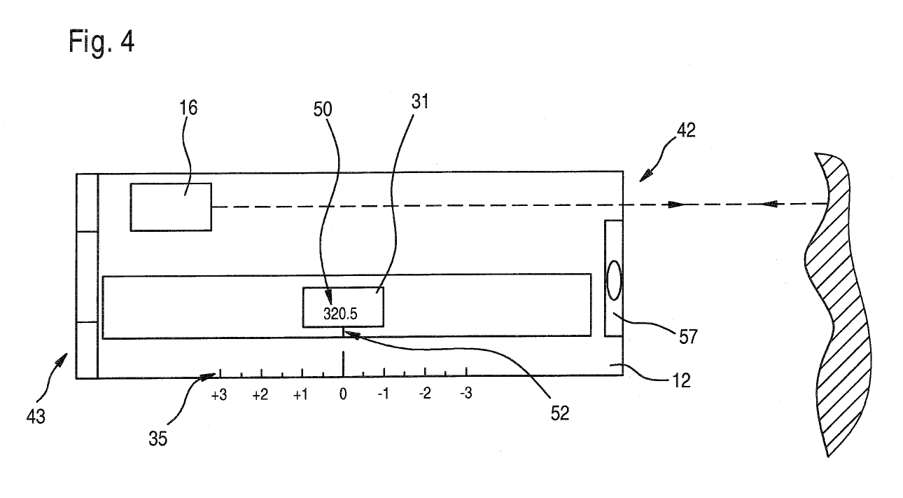

FIG. 4 shows, in a greatly simplified manner, an exemplary embodiment of an output unit 31 of this type. A single measured value 50 (320.5 cm in this case) is advantageously provided with at least one scale mark 52, with which—via its relation to a fixed measurement scale 35 on device housing 12—the measured value itself or relative lengths may be marked off, based on measured value 50, which was measured in a contactless manner. To this end, fixed measurement scale 35 of housing 12 is advantageously designed as a relative scale, and measured value 50, which was determined in a contactless manner, is displayed in a fixed position in output unit 31. To orient the device, a mechanical vial 57 is integrated in housing 12, on end 42 of the device that faces the object. As an alternative, one or more, e.g., electronic tilt sensors may be integrated in the device shown in FIG. 4, or in the other, previously described devices. The position and placement of the vials or the inclinometer may vary, depending on the embodiment.

The tilt sensor makes it possible to use the measuring device and the inclinometer, and to ensure that the device is level when a distance measurement is carried out using the device. This may be realized, e.g., using one or more mechanical vials, or by using an electrical-capacitive system.

In addition, by integrating one or more tilt sensors or position sensors in the housing of the inventive measuring device, the output unit may be designed such that the distance values that are displayed are always displayed in a position that is easiest to read. For example, depending on the orientation of the housing of the measuring device, the numerical value, which is assigned to a scale division, may be rotated, e.g., by 90° or 180° relative to the orientation shown in FIG. 2 merely as an example, to ensure that a user is able to easily read the scale. The digital scale of the inventive output unit therefore ensures that the orientation is favorable for the user, across the entire measurement range and, in particular, across the display range of the device, as indicated by two different possible depictions of the displays of electro-optical output unit in FIG. 2 and FIG. 3.

In addition to the measured length data and any inclination values, the inventive output unit may advantageously also display other values and/or data. For instance, a pocket calculator function may be easily integrated in the device and displayed via the output unit.

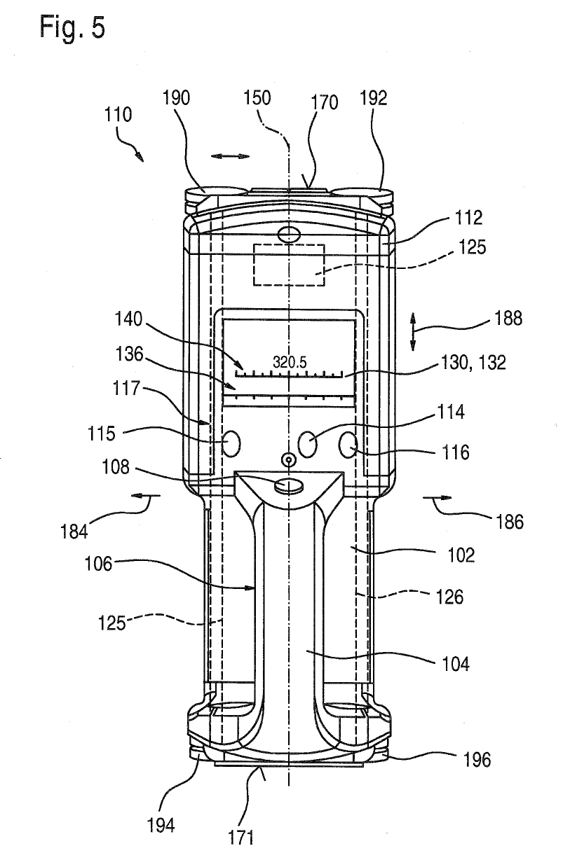

FIG. 5 shows a further exemplary embodiment of a measuring device with an inventive electro-optical output unit 130. Measuring device 110 of the embodiment shown in FIG. 5 may be, e.g., a locating device for detecting objects enclosed in a medium, as known from DE 102 52 425 A1, or it may be designed only as a distance-measuring device, which records distance information using a position-detection system. Within the framework of the description of the inventive object, the possible location function of this measuring device will not be described in greater detail in the description of the measuring device as embodied in FIG. 5. Instead, only the inventive distance-measuring and display function of the measuring device will be described. With regard for a possible configuration of measuring device 110 as a locating device, reference is hereby made, e.g., to DE 102 52 425 A1 or DE 102 04 477 A1.

Housing 112 of inventive measuring device 110 is movable in two preferred, opposite directions of motion 184 and 186, which extend perpendicularly to a longitudinal extension 188 of housing 112 of the measuring device. Measuring device 110 includes four rolling elements 190, 192, 194 and 196, which are designed as wheels and are located in longitudinal extension 188 of the device on diametrically opposed end faces 170 and 171. The rolling elements are located in the transverse extension of device 110, in the outer edge region. Rolling elements 190 and 194, and 192 and 196, which are diametrically opposed in longitudinal direction 188, are non-rotatably connected with each other via rigid axles 124 and 126.

To record motion parameters, measuring device 110 includes a sensor unit with two sensors, in particular, with which the motion parameters may be detected. To this end, segmented wheels are mounted on axles 124 and 126 in a not-shown manner; the segmented wheels move in fork light barriers, thereby enabling the direction of motion of the device to be detected. In addition, the rolling elements—together with axles 124, 126 and the sensor unit for detecting rotation—form a position-detection system, with which the section covered when the measuring device is rolled across a background may be detected and then communicated to a user via display unit 130.

Housing 112 of measuring device 110 includes a holding device 106 on its top side 102 that is designed as a C-shaped handle 104. Holding device 106 extends in longitudinal extension 188 of housing 112. Using holding device 106 and rolling elements 190 through 196, measuring device 110 may be guided over the background of a medium to be measured, e.g., a wall, a floor, or a ceiling.

To perform a distance measurement, inventive measuring device 110 with rolling elements 190 through 196 is placed on a background and is activated, e.g., by actuating a measuring button 108. The measuring device also includes a control panel 117, in which various operating elements 114, 115, and 116 are located, and which are actuated in order to activate various measurement modes. By actuating a particular operating element, in particular, the signal memory for the measured distance values may be reset to zero.

A distance measurement may be carried out using inventive measuring device 110, e.g., as described below.

The measuring device is placed on a background to be measured and is moved into the start position, i.e., at one end of a section to be measured. In this position, the measured distance value memory is reset to zero, thereby specifying the start point of the distance measurement. Inventive measuring device 100 may now be moved via rolling elements 190 through 196 in directions of motion 186 or 184 over the background. The section that is covered is detected via the displacement sensors. A computation and evaluation unit 125, which is located in the housing of measuring device 110, determines the current position of the measuring device and displays this information in output unit 130 of the measuring device. In addition to displaying the current measured value of the section that was covered, output unit 130—which is designed as electro-optical display 132—of measuring device 110 also makes it possible to display a length-measurement scale 140, with which a reference value may be advantageously marked off relative to central axis 150 of the measuring device, and with which relative sections may be marked off. In a particularly advantageous embodiment of an inventive measuring device of this type, output unit 130 is located in the region of end face 170, so that measured values and scale values displayed in the output unit may be transferred directly to the background.

Depending on the size and geometrical extension of output unit 130, a more or less large section of a length-measurement scale 140 may be displayed in the inventive output unit.

FIG. 6 shows a possible embodiment of an inventive output unit 130, in a detailed view. Electronic display 132 includes a digital display with a variable length-measurement scale 140, which is composed of scale marks 156 and assigned numerical values 151. The scale marks and/or numerical values change as the distance between the measuring device and the starting point of the distance measurement—which was set as the reference point—increases or decreases. Scale divisions 156 of 1 cm are shown in exemplary display 132. This scale division of length-measurement scale 140 is subdivided further into 5 mm-increments by additional scale divisions 158.

A further subdivision, e.g., into 1 mm-increments, as shown in the exemplary embodiment in FIG. 5, is also possible, and may be displayed in output unit 130, e.g., if so prompted by the user by his actuating a related operating element 114 through 116. Scale values 151 that indicate the particular distance between scale division 156 and the reference point, i.e., the zero point of the section measurement, are assigned to scale divisions 156. Inventive output unit 130 therefore displays the particular distance between a reference point and a reference plane 150 of measuring device 110, and displays absolute distances 151 between the length-measurement scale and the reference point, within a finite range. The absolute distance between measurement points and a reference point, and, therefore, the distance between these measurement points relative to each other, may be read out, marked off, and, e.g., transferred to a background, across the entire range of the section that is displayable in the output unit. To this end, housing 112 of inventive device 110 also includes a fixed scale division 136, i.e., it is fixed relative to the housing, e.g., across the entire longitudinal extension of output unit 130 and/or across the entire longitudinal extension of housing 112. The “longitudinal extension” refers to the extension of the output unit and/or the housing in direction of motion 184 and/or 186 of the device. A fixed scale division with 1 mm-increments is used in the exemplary embodiment shown in FIG. 5. Other scale divisions are also feasible, of course.

In addition to the embodiment of the electronic length-measurement scale shown in FIG. 6, depending on the application, it is also possible to depict only a portion of the entire measurement range, or to depict only a single measured value, thereby making it possible—as with conventional contactless distance-measuring devices, e.g., laser distance-measuring devices—to also perform individual measurements relative to a reference plane 150 of the device. A single measured value, e.g., 320.5 cm in the exemplary embodiment shown in FIG. 5, may be advantageously provided with at least one scale mark, which, due to its relationship with fixed measurement scale 136, may be used to mark off the measured value and relative lengths, based on this measured value. To this end, fixed measurement scale 136 is advantageously designed as a relative scale, and the distance value that was measured is displayed in a fixed position in output unit 130.

The inventive output unit and/or an inventive measuring device with an output unit of this type are/is not limited to the designs of these exemplary embodiments.

For example, the inventive output unit may be realized using LEDs, OLEDs, LCDs, fluorescent displays (VFDS) or the like. Possible depictions of the digital measurement scale may be realized using a vector-oriented control of the display, grid or matrix displays, or, e.g., segment displays.

The inventive electro-optical display with a variable scale, which changes as the measurement distance varies, may be integrated in a large number of measuring devices. Measuring devices that are used to measure finite distances and/or that require exact knowledge of finite distances are feasible in particular.

Contactless distance measurement is not limited to the use of light signals. Basically, a measuring device of this type may also be realized by using a type of electromagnetic radiation. For example, a radar distance-measuring device may be realized in a similar manner. In addition to the use of modulated measurement radiation, with which measured distance values may be determined using a transit time method or a phase evaluation method, it is also possible to use known triangulation measurement methods in the inventive measuring device.

It should also be noted that the inventive measuring device may also be realized as an ultrasonic measuring device.

The inventive electro-optical output unit may also be integrated in measuring devices for direct distance measurement, as mentioned and described above. In addition to the exemplary embodiment shown in FIG. 4, inventive measuring devices are also possible—for example, and not limited hereto—that are designed as “roller tape” or an optical “measurement mouse”.

What is claimed is:

1. An electro-optical output unit (30, 31, 32, 130, 132) for displaying measured distance values, in particular an electro-optical output unit (30, 31, 32, 130, 132) for a hand-held length-measurement device,
wherein
the output unit (30, 31, 32, 130, 132) may be used to display a variable length-measurement scale (40, 52, 140), which changes as the measuring distance of the device varies relative to a reference point of the distance measurement.

2. The electro-optical output unit as recited in claim 1,
wherein,
using the output unit (30, 31, 32, 130, 132), it is possible to display a variable length-measurement scale (40, 52, 140), which changes as the measurement distance increases or decreases, in accordance with the distance measured between a reference point and a reference point of the device.

3. The electro-optical output unit as recited in claim 1,
wherein
the measurement scale (40, 52, 140) is composed of scale divisions (56, 58) and/or numerical values (50, 51).

4. The electro-optical output unit as recited in claim 1,
wherein
the measurement scale (40, 52, 140) includes numerical values (50, 51), which represent the distance from the related scale division (48, 52, 56, 58) to a reference point of the distance measurement.

5. The electro-optical output unit as recited in claim 1,
wherein
the orientation of the measurement scale (40, 52, 140) relative to the output unit (30, 31, 32, 130, 132) may be switched.

6. The electro-optical output unit as recited in claim 1,
wherein
further data, inclination data in particular, may be displayed using the output unit (30, 31, 32,130, 132).

7. The electro-optical output unit as recited in claim 1,
wherein
the zero point of the length-measurement scale (40, 52, 140) is outside of the measurement range displayed in the output unit (30, 31, 32, 130, 132).

8. The electro-optical output unit as recited in claim 1,
wherein
the output unit (30, 31, 32, 130) is an electronic display (32, 132), in particular a digital electronic display.

9. A measuring device, in particular a hand-held distance-measuring device (10, 110), with an electro-optical output unit (30, 31, 32, 130, 132) as recited in claim 1.

10. The measuring device as recited in claim 9,
wherein
the measuring device (10, 110) includes at least one device (16) for measuring distance in a contactless manner.

11. The measuring device as recited in claim 9,
wherein
the measuring device includes at least one displacement sensor (190 through 196) for measuring distance.

12. The measuring device as recited in claim 9,
wherein
the output unit (30, 31, 32, 130, 132) for displaying the length-measurement scale (40, 140, 52) is located essentially parallel to a lay edge (38, 170) of a housing (12, 112) of the measuring device (10, 110).

13. The measuring device as recited in claim 9,
wherein
the orientation of the measurement scale (40, 140, 52) relative to the housing (12, 112) may be switched.

14. The measuring device as recited in claim 9,
wherein
the housing (12, 112) of the device includes at least one additional scale (34, 36, 134, 136), in particular a fixed scale with marks, which is formed in particular in the region of a lay edge (38, 117) of the housing (12, 112).

15. The measuring device as recited in claim 9,
wherein
the output unit (30, 31, 32, 130, 132) includes an electro-optical display (32, 132) whose dimensions in the measuring direction (17, 184, 186) are greater than they are in the direction orthogonal thereto.
